(19) United States
(12) Patent Application Publication
(10) Pub. No.: US 2026/0321223 A1
(43) Pub. Date: Oct. 15, 2026

(54) Driver, Serial-Parallel Compatible Communication Method for Serially Connected Drivers, and Display System

(71) Applicant: HUAYUAN SEMICONDUCTOR (SHENZHEN) LIMITED COMPANY, Shenzhen (CN)

(72) Inventors: Lei Xia, Shenzhen (CN); Zhangyi Zhu, Shenzhen (CN); Junyue Sun, Shenzhen (CN); Yuanlei Wang, Shenzhen (CN)

(21) Appl. No.: 19/467,896

(22) Filed: Feb. 3, 2026

(30) Foreign Application Priority Data
Feb. 6, 2025 (CN) 202510132599.2

(51) Int. Cl. G09G 5/00

(52) U.S. Cl. CPC G09G 5/006; G09G 2370/10

(57) ABSTRACT

Disclosed are a driver, a serial-parallel compatible communication method therefor under serial connection, and a display system. The driver includes a data serial input port, a data serial output port, a parallel path, a serial path, and a multiplexer. First ends of paths connect to the data serial input port, second ends of paths connect to a first end of the multiplexer, whose second end connects to the data serial output port. The multiplexer obtains a current instruction through the data serial input port during a current data transmission, and controls, according to a path type expected by an instruction for a next data transmission carried in the current instruction, the parallel or serial path to be conducting after the current data transmission is completed. Parallel and serial instruction transmissions can be balanced under a serially connected driver link without configuring additional ports, thereby improving efficiency.

### CROSS REFERENCE TO RELATED APPLICATIONS

The present application claims the benefit of Chinese Patent Application No. 202510132599.2 filed on Feb. 6, 2025, the contents of which are incorporated herein by reference in their entirety.

### TECHNICAL FIELD

The present application relates to the field of display technology, and in particular, to a driver and a serial-parallel compatible communication method under a serial connection thereof, and a display system.

### BACKGROUND ART

Currently, the communication modes of master-slave systems are predominantly serial communication or parallel communication. In serial communication, a master and multiple slaves are connected in a daisy-chain configuration, where data originates from the master and is transmitted downward sequentially through the communication ports of each slave. In parallel communication, the master transmits data by connecting to the communication receiving port of every slave through a port.

In a display system, the system composed of a controller and drivers is a typical one-master-multiple-slave communication link. Display systems usually connect the controller and drivers in a serial cascade manner. Serial connection provides shorter wiring lengths; while ensuring signal quality, it also facilitates routing and reduces the cost of the control panel.

Display systems have inherent limitations regarding frame refresh rates and have stringent timing requirements for data activation, requiring drivers to activate each frame of data simultaneously at a specific frequency. However, with the developmental trend toward larger partition counts and higher refresh rates in display systems, the number of serially cascaded drivers and the length of transmitted data increase, making the communication latency caused by serial communication a bottleneck for the development of display systems. Although parallel communication offers lower data transmission latency and allows all drivers to respond to data simultaneously—where data activation points are naturally aligned—implementing parallel communication within serially connected drivers would require designing more interfaces. This leads to complex wiring and higher implementation costs for the display system.

Therefore, how to balance parallel and serial instruction transmission within a serially connected driver chain to reduce the number of configured ports while improving driver efficiency has become an urgent problem to be solved.

### SUMMARY OF THE INVENTION

In view of this, embodiments of the present application provide a driver, a serial-parallel compatible communication method for serially connected drivers, and a display system to address the issue of balancing parallel and serial instruction transmissions in a serially connected driver link to reduce the number of configured ports while improving driver efficiency.

In a first aspect, an embodiment of the present application provides a driver. The driver includes a data serial input port, a data serial output port, a parallel path, a serial path, and a multiplexer. A first end of the parallel path and a first end of the serial path are connected to the data serial input port. A second end of the parallel path and a second end of the serial path are connected to a first end of the multiplexer, and a second end of the multiplexer is connected to the data serial output port.

The multiplexer is used to obtain a current instruction of a controller received through the data serial input port during a current data transmission. Based on a path type expected by an instruction corresponding to a next data transmission carried in the current instruction, the multiplexer controls the parallel path or the serial path to be conducting after the current data transmission is completed.

In a second aspect, an embodiment of the present application provides a serial-parallel compatible communication method for serially connected drivers. The method is applied to a driver. A driver link formed by at least one serially connected driver is connected to a controller. The serial-parallel compatible communication method for serially connected drivers includes:
obtaining a current instruction sent by the controller during a current data transmission, wherein the current instruction includes instruction information and a path type expected by an instruction corresponding to a next data transmission;
forwarding the current instruction according to a path type corresponding to the current instruction; and
after the current instruction is forwarded, determining that the current data transmission is completed, and controlling a parallel path or a serial path to be conducting according to the path type expected by the instruction.

In a third aspect, an embodiment of the present application provides a serial-parallel compatible communication method for serially connected drivers. This method is applied to a controller. The controller is connected to at least one driver link. The driver link includes at least one driver described in the first aspect connected in series. The serial-parallel compatible communication method for serially connected drivers includes:
obtaining instruction information for a current data transmission and a path type expected by an instruction corresponding to a next data transmission, and forming a current instruction using the instruction information and the path type expected by the instruction; and
sending the current instruction to the driver, wherein the current instruction is used for transmission through a path type corresponding to the current instruction, and the path type expected by the instruction is used for controlling, after the current data transmission is completed, a parallel path or a serial path of the driver to be conducting.

In a fourth aspect, an embodiment of the present application provides a display system. The display system includes a controller and a driver link formed by at least one driver described in the first aspect connected in series. A first port of the controller is connected to a first driver in the driver link to send instructions to all drivers.

Compared with the prior art, the beneficial effects of the embodiments of the present application include: the driver of the present application includes a data serial input port, a data serial output port, a parallel path, a serial path, and a multiplexer. First ends of the parallel path and the serial path connect to the data serial input port. Second ends of the parallel path and the serial path connect to a first end of the multiplexer, and a second end of the multiplexer connects to the data serial output port. The multiplexer is used to obtain a current instruction of a controller received through the data serial input port during a current data transmission. Based on a path type expected by an instruction corresponding to a next data transmission carried in the current instruction, the multiplexer controls the parallel path or the serial path to be conducting after the current data transmission is completed. The driver link formed by the serial connection of the drivers described above can control arbitrary switching between serial and parallel modes according to the path type expected by an instruction in the current instruction. This allows the controller to flexibly switch the data transmission mode via each instruction, performing parallel transmission for instructions that can be transmitted in parallel to improve efficiency, while performing serial transmission for instructions that can be transmitted serially to ensure the effectiveness of instruction functions.

### DESCRIPTION OF THE DRAWINGS

To illustrate the technical solutions in the embodiments of the present application or the prior art more clearly, the drawings used in the description of the embodiments or the prior art are briefly introduced below. Apparently, the drawings described below represent only some embodiments of the present application. For those skilled in the art, other drawings can be obtained based on these drawings without creative effort.

FIG. 1 is a structural schematic diagram of a driver provided by Embodiment 1 of the present application.

FIG. 2 is a communication schematic diagram of a parallel working state provided by Embodiment 1 of the present application.

FIG. 3 is a communication schematic diagram of a serial working state provided by Embodiment 1 of the present application.

FIG. 4 is a structural schematic diagram of a display system provided by Embodiment 2 of the present application.

FIG. 5 is a timing schematic diagram of instruction communication provided by Embodiment 2 of the present application.

FIG. 6 is a structural schematic diagram of a display system provided by Embodiment 3 of the present application.

FIG. 7 is a timing schematic diagram of instruction communication provided by Embodiment 3 of the present application.

FIG. 8 is a flowchart of a serial-parallel compatible communication method for serially connected drivers provided by Embodiment 4 of the present application.

FIG. 9 is a flowchart of a serial-parallel compatible communication method for serially connected drivers provided by Embodiment 5 of the present application.

### DETAILED DESCRIPTION

In the following description, for purposes of illustration rather than limitation, specific details such as specific system structures and techniques are provided to facilitate a thorough understanding of the embodiments of the present application. However, it should be clear to those skilled in the art that the present application may be implemented in other embodiments without these specific details. In other cases, detailed descriptions of well-known systems, devices, circuits, and methods are omitted to avoid unnecessary details hindering the description of the present application.

It should be understood that, when used in the specification of the present application and the appended claims, the term “comprise” indicates the presence of described features, integers, steps, operations, elements, and/or components, but does not exclude the presence or addition of one or more other features, integers, steps, operations, elements, components, and/or groups thereof.

It should also be understood that the term “and/or” used in the specification of the present application and the appended claims refers to any and all possible combinations of one or more of the associated listed items, and includes these combinations.

As used in the specification of the present application and the appended claims, the term “if” may be interpreted as “when” or “once” or “in response to determining” or “in response to detecting” depending on the context. Similarly, the phrase “if it is determined” or “if [the described condition or event] is detected” may be interpreted as “once it is determined” or “in response to determining” or “once [the described condition or event] is detected” or “in response to detecting [the described condition or event]” depending on the context.

In addition, in the description of the specification of the present application and the appended claims, the terms “first,” “second,” “third,” etc., are used only to distinguish descriptions and should not be understood as indicating or implying relative importance.

References to “one embodiment” or “some embodiments” described in the specification of the present application mean that specific features, structures, or characteristics described in connection with the embodiment are included in one or more embodiments of the present application. Thus, phrases such as “in one embodiment,” “in some embodiments,” “in other embodiments,” “in still other embodiments,” etc., appearing in different places in this specification do not necessarily all refer to the same embodiment, but instead mean “one or more but not all embodiments,” unless otherwise specifically emphasized. The terms “include,” “contain,” “have,” and their variations all mean “including but not limited to,” unless otherwise specifically emphasized.

It should be understood that the sequence of the serial numbers of the steps in the following embodiments does not mean the execution order. The execution order of each process should be determined by its function and internal logic, and should not constitute any limitation on the implementation process of the embodiments of the present application.

To illustrate the technical solutions of the present application, specific embodiments are described below.

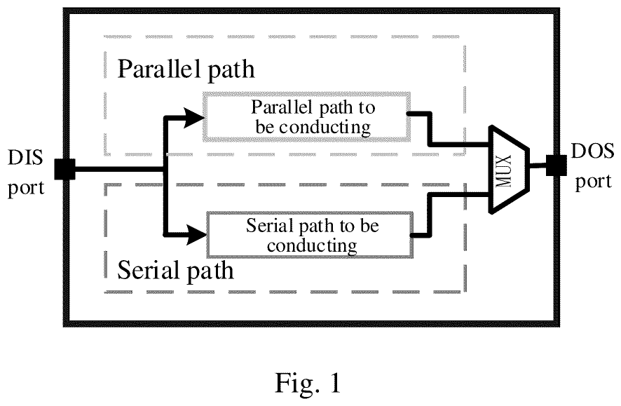

Referring to FIG. 1, which is a structural schematic diagram of a driver provided by Embodiment 1 of the present application, the driver includes a data serial input port (Data Input Series, DIS port), a data serial output port (Data Output Series, DOS port), a parallel path, a serial path, and a multiplexer. A first end of the parallel path and a first end of the serial path are connected to the data serial input port. A second end of the parallel path and a second end of the serial path are connected to a first end of the multiplexer, and a second end of the multiplexer is connected to the data serial output port. The multiplexer is used to obtain a current instruction of a controller received through the data serial input port during a current data transmission. Based on a path type expected by an instruction corresponding to a next data transmission carried in the current instruction, the multiplexer controls the parallel path or the serial path to be conducting after the current data transmission is completed.

The DIS port and DOS port of the driver are connected to form a driver link. If the driver link includes only one driver, the DIS port of the driver is used to connect to a controller. If the driver link includes at least two drivers, the DIS port of the first driver is used to connect to the controller, the DOS port of the first driver connects to the next driver, and so on, to achieve a serial connection of the drivers.

On the basis of this serial connection, the parallel path, the serial path, and the multiplexer are designed inside the driver. The parallel path and the serial path are connected to the multiplexer respectively, and the multiplexer controls the parallel path or the serial path to be conducting according to the path type expected by the instruction.

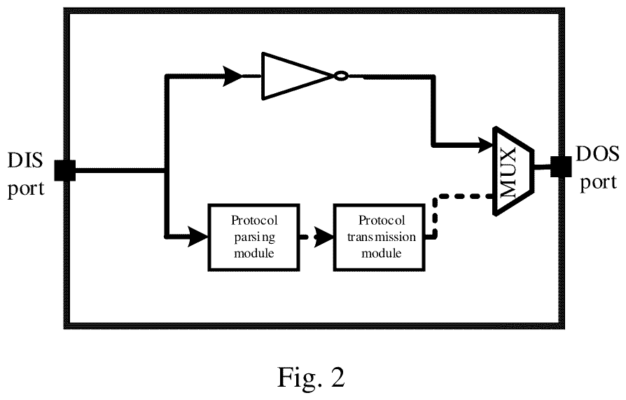

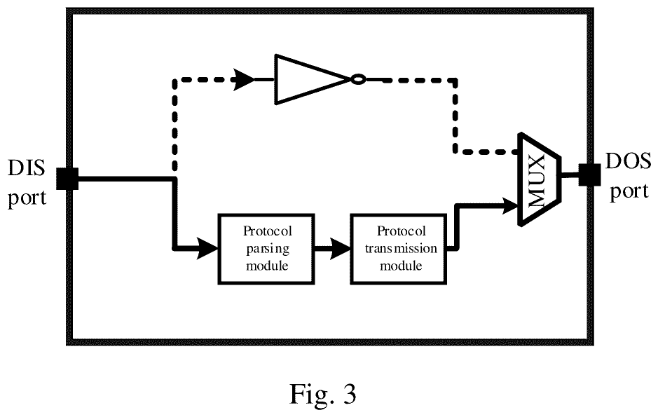

As shown in FIGS. 2 and 3, which are communication schematic diagrams in parallel and serial working states, when the driver switches to the parallel path mode, the DIS port and DOS port are directly connected inside the driver. One path of signals from the DIS port is output directly from the DOS port through a buffer without being processed by the driver. Another path enters the protocol parsing module for parsing but is not transmitted after parsing. When the drivers in the link all switch to the parallel path mode, the transmission delay generated during data transmission along the link is small, data response timeliness is high, and each driver can respond to data synchronously. This is suitable for issuing brightness information and configuration information. When the driver switches to the serial path mode, data received by the DIS port enters the protocol parsing module for processing and is output through the DOS port after being updated by the protocol transmission module to realize functions such as address allocation and data readback.

For example, if the current instruction is a dimming instruction, it requires strong timeliness. Therefore, the dimming instruction needs to be transmitted in parallel; that is, the parallel path in the driver needs to be conducting so that the dimming instruction can be transmitted directly through the driver. When the previous instruction was sent, it already delivered the expected path type for the current instruction as “parallel” to the driver. After executing the previous instruction and before executing the current instruction, the driver makes the parallel path conducting. At this point, the dimming instruction can be transmitted downward directly through the driver. If the parallel path was conducting during the transmission of the previous instruction, this conducting state is maintained. If the serial path was conducting during the transmission of the previous instruction, the conducting state is switched from the serial path to the parallel path. Naturally, this dimming instruction also contains the path type expected by the instruction. If the next instruction corresponding to the next data transmission is a readback instruction requiring serial transmission, the dimming instruction includes a serial path type. After the multiplexer obtains the dimming instruction and completes its transmission, it switches from the parallel path being conducting to the serial path being conducting according to the serial requirement.

The response of drivers to dimming data in display systems has strong timeliness, requiring drivers to complete data transmission and activation within a specified time window to meet refresh rate requirements. To ensure consistency of the display image, various drivers in the system are required to simultaneously activate a certain frame of data at the same time point. The parallel transmission method described above can effectively improve data refresh efficiency. The communication link should also have the ability to read back status information from the driver to meet certain debugging and control needs of the controller, and the serial method can ensure the accuracy of driver readback.

In one embodiment, when the path type expected by the instruction is parallel, the parallel path is controlled to be conducting so that the next instruction corresponding to the next data transmission is transmitted directly from the data serial input port to the data serial output port. As shown in FIG. 2, in the parallel path, one path of signals from the DIS port is output directly from the DOS port through a buffer without being processed by the driver, while another path enters the protocol parsing module for parsing but is not transmitted. Therefore, data can be transmitted directly from the DIS port to the DOS port, improving efficiency while ensuring communication effectiveness and security.

In one embodiment, a protocol parsing module is provided on the serial path. When the path type expected by the instruction is serial, the serial path is controlled to be conducting, allowing the next instruction corresponding to the next data transmission to enter the protocol parsing module for parsing. After parsing, the next instruction is transmitted to the data serial output port. The protocol parsing module is used to parse received instructions to complete their execution. After parsing, the instruction is sent to the next driver through the DOS port via the protocol transmission module. After reaching the last driver, the instruction can be connected back to the receiving port of the controller through its DOS port. The controller then parses the data to obtain information from inside the driver.

The protocol parsing module can consist of a master node and a slave node. Instruction parsing and transmission tasks can be effectively completed through parsing by the master node in coordination with data forwarding at the port by the slave node.

In embodiments of the present application, the driver includes a data serial input port, a data serial output port, a parallel path, a serial path, and a multiplexer. A first end of the parallel path and a first end of the serial path connect to the data serial input port. A second end of the parallel path and a second end of the serial path connect to a first end of the multiplexer, and a second end of the multiplexer connects to the data serial output port. The multiplexer is used to obtain a current instruction of a controller received through the data serial input port during a current data transmission. Based on a path type expected by an instruction corresponding to a next data transmission carried in the current instruction, the multiplexer controls the parallel path or the serial path to be conducting after the current data transmission is completed. The driver link formed by the serial connection of the drivers can control arbitrary switching between serial and parallel modes according to the path type expected by an instruction in the current instruction. This allows the controller to flexibly switch the data transmission mode via each instruction, performing parallel transmission for instructions that can be transmitted in parallel to improve efficiency, while performing serial transmission for instructions that can be transmitted serially to ensure the effectiveness of instruction functions.

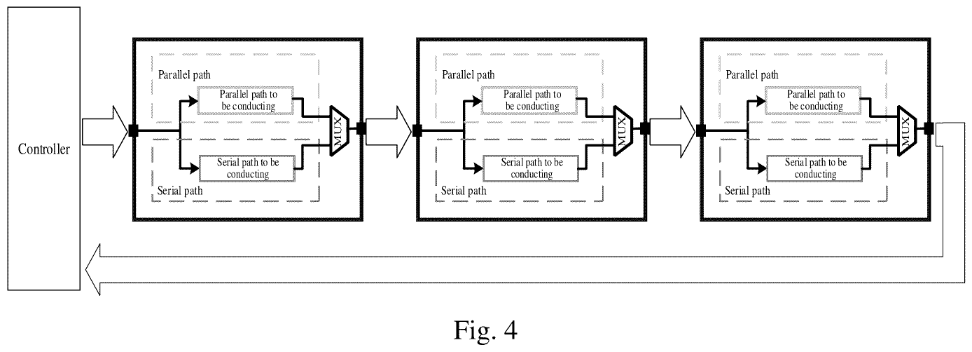

Referring to FIG. 4, which is a structural schematic diagram of a display system provided by Embodiment 2 of the present application, three drivers connected in series are taken as an example in FIG. 4. The display system includes a controller and a driver link formed by at least one driver connected in series. A first port of the controller is connected to a first driver in the driver link to send instructions to all drivers.

The driver includes a data serial input port, a data serial output port, a parallel path, a serial path, and a multiplexer. A first end of the parallel path and a first end of the serial path connect to the data serial input port. A second end of the parallel path and a second end of the serial path connect to a first end of the multiplexer, and a second end of the multiplexer connects to the data serial output port. The multiplexer is used to obtain a current instruction of a controller received through the data serial input port during a current data transmission. Based on a path type expected by an instruction corresponding to a next data transmission carried in the current instruction, the multiplexer controls the parallel path or the serial path to be conducting after the current data transmission is completed.

In one embodiment, when the path type expected by the instruction is parallel, the parallel path is controlled to be conducting so that the next instruction corresponding to the next data transmission is transmitted directly from the data serial input port to the data serial output port.

In one embodiment, a protocol parsing module is provided on the serial path. When the path type expected by the instruction is serial, the serial path is controlled to be conducting, allowing the next instruction corresponding to the next data transmission to enter the protocol parsing module for parsing. After parsing, the next instruction is transmitted to the data serial output port.

The above definitions regarding the structure of the driver have been explained in Embodiment 1. Reference can be made to the description of Embodiment 1, and details are not repeated here.

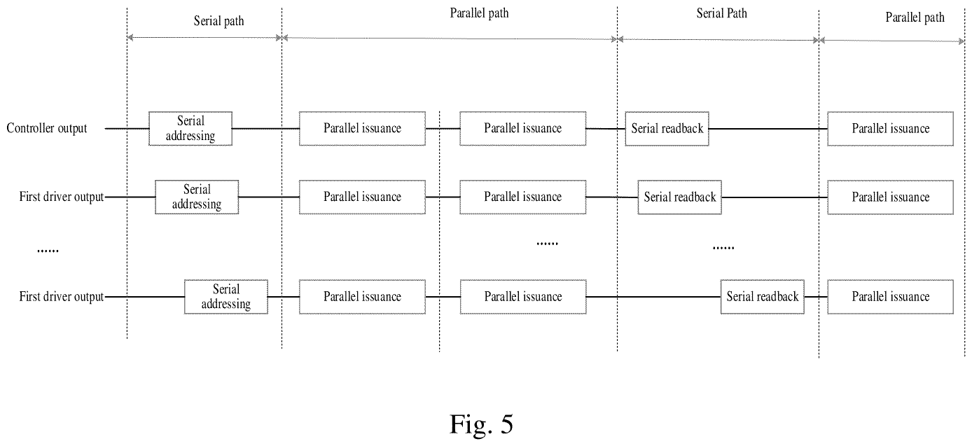

As shown in FIG. 5, which is a timing schematic diagram of instruction communication provided by Embodiment 2 of the present application, after the controller outputs serial instructions such as serial addressing and serial readback, the drivers from the first one to the last one receive the corresponding instructions sequentially. After the controller outputs parallel instructions such as brightness information and configuration information, ignoring signal transmission delay, the drivers from the first one to the last one receive the parallelly issued instructions almost simultaneously. The serial path and the parallel path switch autonomously based on the path type for the next instruction carried in the previous instruction.

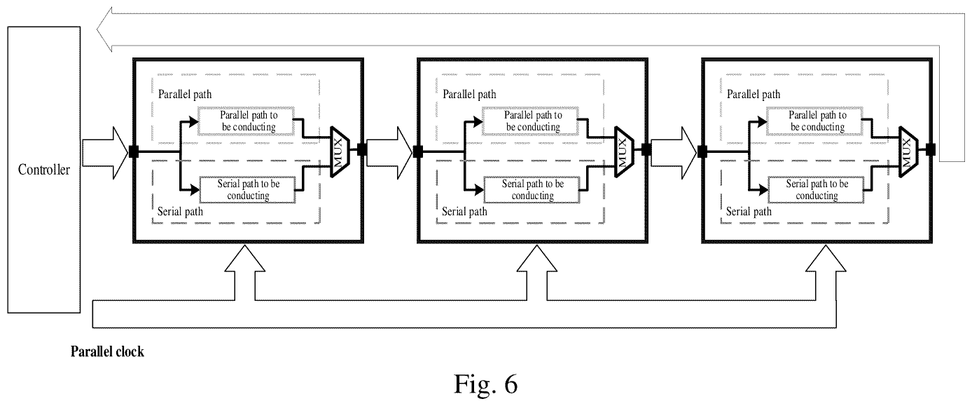

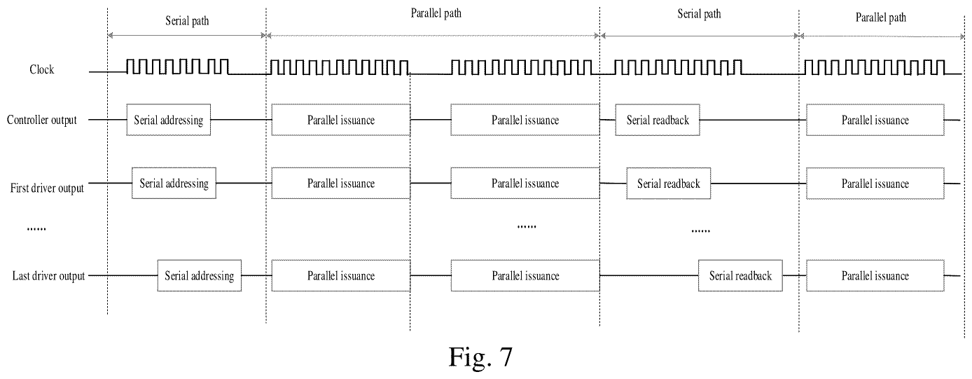

Referring to FIG. 6, which is a structural schematic diagram of a display system provided by Embodiment 3 of the present application, based on Embodiment 2 described above, a third end is provided on the serial path. The second port of the controller connects to the third ends of all drivers in the driver link to send instructions simultaneously to the serial paths. Since the controller is connected to the serial path of each driver, it can send instructions simultaneously to these serial paths, such as parallel clock instructions. The parallel clock instruction is used to instruct all drivers to execute corresponding instructions simultaneously at the same time point after receiving the instructions. As shown in FIG. 7, which is a timing schematic diagram of instruction communication provided by Embodiment 3 of the present application, clocks are issued simultaneously to each driver, so that at the end of each clock, all drivers can execute corresponding instructions simultaneously.

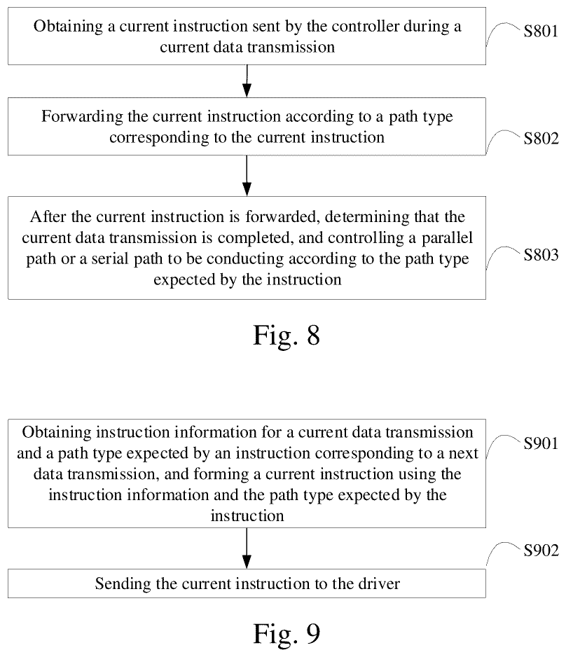

Referring to FIG. 8, which is a flowchart of a serial-parallel compatible communication method for serially connected drivers provided by Embodiment 4 of the present application, the serial-parallel compatible communication method for serially connected drivers is applied to a driver. A driver link formed by at least one serially connected driver is connected to a controller.

As shown in FIG. 8, for the driver, the serial-parallel compatible communication method for serially connected drivers includes the following steps:

Step S801: Obtaining a current instruction sent by the controller during a current data transmission.

The current instruction includes instruction information and a path type expected by an instruction corresponding to a next data transmission.

Step S802: Forwarding the current instruction according to a path type corresponding to the current instruction.

Step S803: After the current instruction is forwarded, determining that the current data transmission is completed, and controlling a parallel path or a serial path to be conducting according to the path type expected by the instruction.

These steps have been explained in the embodiments corresponding to the driver. Reference can be made to the descriptions in the previous driver embodiments, and details are not repeated here.

Optionally, controlling a parallel path or a serial path to be conducting according to the path type expected by the instruction includes:
if the path type corresponding to the current instruction is parallel and the path type expected by the instruction is parallel, maintaining the parallel path to be conducting;
if the path type corresponding to the current instruction is parallel and the path type expected by the instruction is serial, switching from the parallel path being conducting to the serial path being conducting;
if the path type corresponding to the current instruction is serial and the path type expected by the instruction is serial, maintaining the serial path to be conducting; and
if the path type corresponding to the current instruction is serial and the path type expected by the instruction is parallel, switching from the serial path being conducting to the parallel path being conducting.

For the driver, two operations—maintaining and switching—are designed for the parallel path and the serial path. If the required path is consistent with the original path, the state is maintained; if it is inconsistent with the original path, the state is switched.

Optionally, forwarding the current instruction according to a path type corresponding to the current instruction includes:
if the path type corresponding to the current instruction is parallel, transmitting the current instruction directly from a data serial input port of the driver to a data serial output port of the driver.

In the parallel path, two paths are designed. One path transmits data directly through a buffer, and the other path receives data for parsing but does not transmit the parsed results. Therefore, data can be transmitted directly from the DIS port to the DOS port, improving efficiency while ensuring communication effectiveness and security.

Optionally, forwarding the current instruction according to a path type corresponding to the current instruction includes:
if the path type corresponding to the current instruction is serial, parsing the current instruction and executing the instruction information in the current instruction; and after the parsing is completed, transmitting the current instruction to a data serial output port of the driver.

The received instruction is parsed to complete the execution of the instruction. After parsing, the instruction is further transmitted and sent through the DOS port to the next driver or to reach the last driver.

Referring to FIG. 9, which is a flowchart of a serial-parallel compatible communication method for serially connected drivers provided by Embodiment 5 of the present application, the serial-parallel compatible communication method for serially connected drivers is applied to a controller. The controller connects to at least one driver link, and the driver link includes at least one driver connected in series.

As shown in FIG. 9, for the controller, the serial-parallel compatible communication method for serially connected drivers includes the following steps:

Step S901: Obtaining instruction information for a current data transmission and a path type expected by an instruction corresponding to a next data transmission, and forming a current instruction using the instruction information and the path type expected by the instruction.

Step S902: Sending the current instruction to the driver.

The current instruction is used for transmission through a path type corresponding to the current instruction, and the path type expected by the instruction is used for controlling, after the current data transmission is completed, a parallel path or a serial path of the driver to be conducting.

These steps have been explained in the execution process of the controller in the embodiments corresponding to the display system. Reference can be made to the description of the controller in the previous embodiments, and details are not repeated here.

It should be noted that, since content such as the information interaction and execution processes between the above modules is based on the same concept as the method embodiments of the present application, their specific functions and resulting technical effects can be found in the descriptions of the method embodiments, and details are not repeated here.

In the above embodiments, the description of each embodiment has its own focus. For parts that are not described in detail or recorded in a certain embodiment, reference can be made to relevant descriptions in other embodiments.

Those of ordinary skill in the art will recognize that the units and algorithm steps of the examples described in connection with the embodiments disclosed herein can be implemented by electronic hardware or a combination of computer software and electronic hardware. Whether these functions are performed by hardware or software depends on the specific application and design constraints of the technical solution. Professionals may use different methods to implement the described functions for each specific application, but such implementation should not be considered as exceeding the scope of the present application.

In the embodiments provided in the present application, it should be understood that the disclosed device/computer equipment and method may be implemented in other ways. For example, the device/computer equipment embodiments described above are merely illustrative. For instance, the division of modules or units is only a logical functional division. In actual implementation, there may be other division methods. For example, multiple units or components can be combined or integrated into another system, or some features can be ignored or not executed. Additionally, the mutual coupling, direct coupling, or communication connection shown or discussed can be an indirect coupling or communication connection through some interfaces, devices, or units, and can be in electrical, mechanical, or other forms.

Units described as separate components may or may not be physically separate. Components shown as units may or may not be physical units; that is, they may be located in one place or distributed across multiple network units. Some or all of the units can be selected according to actual needs to achieve the objectives of the solutions in the embodiments.

The above embodiments are only used to illustrate the technical solutions of the present application, rather than to limit them. Although the present application has been described in detail with reference to the foregoing embodiments, those of ordinary skill in the art should understand that they can still modify the technical solutions recorded in the foregoing embodiments or perform equivalent replacements on some technical features. These modifications or replacements do not make the essence of the corresponding technical solutions deviate from the spirit and scope of the technical solutions of the embodiments of the present application, and all should be included within the protection scope of the present application.

1. A driver, comprising:
a data serial input port, a data serial output port, a parallel path, a serial path, and a multiplexer;
wherein a first end of the parallel path and a first end of the serial path are connected to the data serial input port, a second end of the parallel path and a second end of the serial path are connected to a first end of the multiplexer, and a second end of the multiplexer is connected to the data serial output port; and
wherein the multiplexer is configured to obtain a current instruction of a controller received through the data serial input port during a current data transmission, and control, according to a path type expected by an instruction corresponding to a next data transmission carried in the current instruction, the parallel path or the serial path to be conducting after the current data transmission is completed.

2. The driver of claim 1, wherein when the path type expected by the instruction is parallel, the parallel path is controlled to be conducting, such that a next instruction corresponding to the next data transmission is directly transmitted from the data serial input port to the data serial output port.

3. The driver of claim 1, wherein a protocol parsing module is provided on the serial path; and when the path type expected by the instruction is serial, the serial path is controlled to be conducting, such that a next instruction corresponding to the next data transmission enters the protocol parsing module to be parsed, and then the next instruction is transmitted to the data serial output port.

4. A serial-parallel compatible communication method for serially connected drivers, wherein the serial-parallel compatible communication method for serially connected drivers is applied to a driver, a driver link formed by at least one serially connected driver is connected to a controller, and the serial-parallel compatible communication method for serially connected drivers comprises:
obtaining a current instruction sent by the controller during a current data transmission, wherein the current instruction comprises instruction information and a path type expected by an instruction corresponding to a next data transmission;
forwarding the current instruction according to a path type corresponding to the current instruction; and
after the current instruction is forwarded, determining that the current data transmission is completed, and controlling a parallel path or a serial path to be conducting according to the path type expected by the instruction.

5. The serial-parallel compatible communication method for serially connected drivers of claim 4, wherein the controlling a parallel path or a serial path to be conducting according to the path type expected by the instruction comprises:
if the path type corresponding to the current instruction is parallel and the path type expected by the instruction is parallel, maintaining the parallel path to be conducting;
if the path type corresponding to the current instruction is parallel and the path type expected by the instruction is serial, switching from the parallel path being conducting to the serial path being conducting;
if the path type corresponding to the current instruction is serial and the path type expected by the instruction is serial, maintaining the serial path to be conducting; and
if the path type corresponding to the current instruction is serial and the path type expected by the instruction is parallel, switching from the serial path being conducting to the parallel path being conducting.

6. The serial-parallel compatible communication method for serially connected drivers of claim 4, wherein the forwarding the current instruction according to a path type corresponding to the current instruction comprises:
if the path type corresponding to the current instruction is parallel, transmitting the current instruction directly from a data serial input port of the driver to a data serial output port of the driver.

7. The serial-parallel compatible communication method for serially connected drivers of claim 4, wherein the forwarding the current instruction according to a path type corresponding to the current instruction comprises:
if the path type corresponding to the current instruction is serial, parsing the current instruction and executing the instruction information in the current instruction; and
after the parsing is completed, transmitting the current instruction to a data serial output port of the driver.

8. A serial-parallel compatible communication method for serially connected drivers, wherein the serial-parallel compatible communication method for serially connected drivers is applied to a controller, the controller is connected to at least one driver link, the driver link comprises at least one driver of claim 1 connected in series, and the serial-parallel compatible communication method for serially connected drivers comprises:
obtaining instruction information for a current data transmission and a path type expected by an instruction corresponding to a next data transmission, and forming a current instruction using the instruction information and the path type expected by the instruction; and
sending the current instruction to the driver, wherein the current instruction is used for transmission through a path type corresponding to the current instruction, and the path type expected by the instruction is used for controlling, after the current data transmission is completed, a parallel path or a serial path of the driver to be conducting.

9. A display system, comprising:
a driver link formed by at least one driver of claim 1 connected in series; and
a controller, wherein a first port of the controller is connected to a first driver in the driver link to send instructions to all drivers.

10. The display system of claim 9, wherein a third end is provided on the serial path; and a second port of the controller is connected to the third ends of all drivers in the driver link to simultaneously send instructions to the serial paths.

11. A serial-parallel compatible communication method for serially connected drivers, wherein the serial-parallel compatible communication method for serially connected drivers is applied to a controller, the controller is connected to at least one driver link, the driver link comprises at least one driver of claim 2 connected in series, and the serial-parallel compatible communication method for serially connected drivers comprises:
obtaining instruction information for a current data transmission and a path type expected by an instruction corresponding to a next data transmission, and forming a current instruction using the instruction information and the path type expected by the instruction; and
sending the current instruction to the driver, wherein the current instruction is used for transmission through a path type corresponding to the current instruction, and the path type expected by the instruction is used for controlling, after the current data transmission is completed, a parallel path or a serial path of the driver to be conducting.

12. A serial-parallel compatible communication method for serially connected drivers, wherein the serial-parallel compatible communication method for serially connected drivers is applied to a controller, the controller is connected to at least one driver link, the driver link comprises at least one driver of claim 3 connected in series, and the serial-parallel compatible communication method for serially connected drivers comprises:
obtaining instruction information for a current data transmission and a path type expected by an instruction corresponding to a next data transmission, and forming a current instruction using the instruction information and the path type expected by the instruction; and
sending the current instruction to the driver, wherein the current instruction is used for transmission through a path type corresponding to the current instruction, and the path type expected by the instruction is used for controlling, after the current data transmission is completed, a parallel path or a serial path of the driver to be conducting.

13. A display system, comprising:
a driver link formed by at least one driver of claim 2 connected in series; and
a controller, wherein a first port of the controller is connected to a first driver in the driver link to send instructions to all drivers.

14. A display system, comprising:
a driver link formed by at least one driver of claim 3 connected in series; and
a controller, wherein a first port of the controller is connected to a first driver in the driver link to send instructions to all drivers.
